(19) United States
(12) Patent Application Publication
(10) Pub. No.: US 2018/0292603 A1
(43) Pub. Date: Oct. 11, 2018

(54) REAR COVER OF BACKLIGHT MODULE, BACKLIGHT MODULE AND DISPLAY MODULE

(71) Applicant: HEYI INTELLIGENT TECHNOLOGY (SHENZHEN) CO., LTD, Beijing (CN)

(72) Inventors: Yajun Yu, Beijing (CN); Qian CAO, Beijing (CN); Wenhua SU, Beijing (CN); Jian YAO, Beijing (CN); Baivu PAN, Beijing (CN); Ji WANG, Beijing (CN)

(21) Appl. No.: 15/573,946

(22) PCT Filed: Sep. 13, 2016
(86) PCT No.: PCT/CN2016/098784

§ 371 Date: Nov. 14, 2017

(30) Foreign Application Priority Data
Nov. 19, 2015 (CN) 201510812786.1

(51) Int. Cl. F21V 8/00

(52) U.S. Cl. CPC G02B 6/0088; G02B 6/0091

(57) ABSTRACT

The disclosure relates to a rear cover of backlight module, a backlight module and a display module. The rear cover includes a bottom plate and one or more side plates, wherein an accommodating cavity is formed by the side plates and the bottom plate, an inner surface of a side plate is provided with a protrusion protruding toward inside of the accommodating cavity, and a groove used to accommodate the backlight source and fix a light guide plate is formed between the protrusion and the bottom plate. The backboard, the plastic central frame and the front frame of a display module such as television are integrated into one. This dramatically reduces the components or the key materials for the display module, thereby shortening the supply chain and saving the cost for the materials. Several key materials are integrated into one, so that the cost may be lowered. The rear cover with a simplified design can help to save the working hours and labors and eliminate incompatibility between the materials, so that the precision of assembly and the yield of production can be greatly improved.

### CROSS REFERENCE TO RELATED APPLICATIONS

This application is the national stage, under 35 USC 371 of PCT application PCT/CN2016/098784, filed on Sep. 13, 2016, and claims the benefit of Chinese Patent Application No. 201510812786.1, filed on Nov. 19, 2015, the entire contents of which are incorporated herein by reference.

### TECHNICAL FIELD

The present disclosure relates to the field of display, and more particularly, to a rear cover of backlight module, a backlight module and a display module.

### BACKGROUND

The structure of some backlight modules or display modules can be extremely complicated. As shown in FIG. 1, a backlight module may include a front frame, a display panel, optical means, a plastic central frame, a metal backboard, a cover for PCB (Printed Circuit Board), and so on. The optical means may include a LGP (Light Guide Plate) and a reflective sheet. Each of the components may need to be assembled manually, for example, the front frame and the backboard may need to be screwed together.

Some backlight modules or display modules have various disadvantages. For example, it can be troublesome to maintain the supply chain, and to provide management and control for including a large number of components. The cost for manufacturing can be high if the module includes a large number of materials, and it may be time-consuming and may require high cost of labor and material as there may be a large quantity of materials and they may need to be assembled manually.

### SUMMARY

In one aspect, in general, the present disclosure describes a simplified rear cover of backlight module which can be used to assemble a backlight module or a display module conveniently.

In another aspect, in general, the present disclosure describes a rear cover of a backlight module, comprising a bottom plate and a side plate, wherein an accommodating cavity is formed by the side plate and the bottom plate.

Aspects can include one or more of the following features.

A protrusion protruding toward inside of the accommodating cavity is provided on an inner surface of the side plate, and a groove configured to accommodate a backlight source and fix a light guide plate is formed between the protrusion and the bottom plate.

Regarding the above rear cover of backlight module, in one possible implementation, a recess configured to accommodate electrical connection terminals of the backlight source is provided on a part of the bottom plate adjacent to the groove.

Regarding the above rear cover of backlight module, in one possible implementation, a plurality of film hangers are provided on the protrusion such that an optical film locating above the light guide plate is capable of being hitched to the film hangers.

Regarding the above rear cover of backlight module, in one possible implementation, the protrusion is provided on inner surfaces of two side plates facing each other.

Regarding the above rear cover of backlight module, in one possible implementation, a step structure is formed on a part of the inner surface of the side plate that is not provided with the protrusion, and an upper surface of the step structure is located in a same plane with an upper surface of the protrusion, so as to support and fix a display panel cooperatively.

Regarding the above rear cover of backlight module, in one possible implementation, the side plate is configured to extend in a direction substantially perpendicular to an upper surface of the bottom plate, and the protrusion is configured to extend in a direction substantially parallel with the inner surface of the side plate.

Regarding the above rear cover of backlight module, in one possible implementation, the rear cover is formed by a plastic material.

Regarding the above rear cover of backlight module, in one possible implementation, the rear cover is integrally formed.

In another aspect, in general, a backlight module is formed by assembling a rear cover, a reflective sheet, a backlight source, a light guide plate and an optical film sequentially, the rear cover might be the rear cover of backlight module having any structure according to the embodiments of the present disclosure.

In another aspect, in general, a display module, comprises a backlight module and a display panel, where the backlight module might be the backlight module having any structure according to the embodiments of the present disclosure, and the display panel is configured to cover the optical film of the backlight module from above and to be fixed to the protrusion located on the side plate of the rear cover of the backlight module.

Aspects may have one or more of the following advantages. The backboard, the plastic central frame and the front frame of a display module such as a television are integrated into one. This dramatically reduces the components or the key materials for the display module, thereby shortening the supply chain and saving the cost for the materials. Several key materials may be integrated into one, so that the cost may be lowered. The rear cover with a simplified design can help to save working hours and labor and eliminate incompatibility between the materials, so that the precision of assembly and the yield of production can be greatly improved.

Additional features and aspects of the present disclosure will become apparent from the following description of exemplary embodiments with reference to the attached drawings.

### BRIEF DESCRIPTION OF THE DRAWINGS

The drawings, which are incorporated in and constitute part of the specification, together with the description, illustrate exemplary embodiments, features and aspects of the present disclosure and serve to explain the principles of the present disclosure.

FIG. 1 is a diagram showing the structure of a display module.

FIG. 2 is an overall diagram of a rear cover of backlight module according to an embodiment of the present disclosure.

FIG. 3 and FIG. 4 are enlarged diagrams respectively showing a part of a rear cover of backlight module according to an embodiment of the present disclosure.

FIG. 5 and FIG. 6 are diagrams respectively showing the assembling of a rear cover of backlight module according to an embodiment of the present disclosure.

FIG. 7 is a diagram showing a recess provided in a rear cover of backlight module according to an embodiment of the present disclosure.

FIG. 8 and FIG. 9 are diagrams respectively showing a film hanger provided in a rear cover of backlight module according to an embodiment of the present disclosure.

FIG. 10 is a structural diagram of a display module according to an embodiment of the present disclosure.

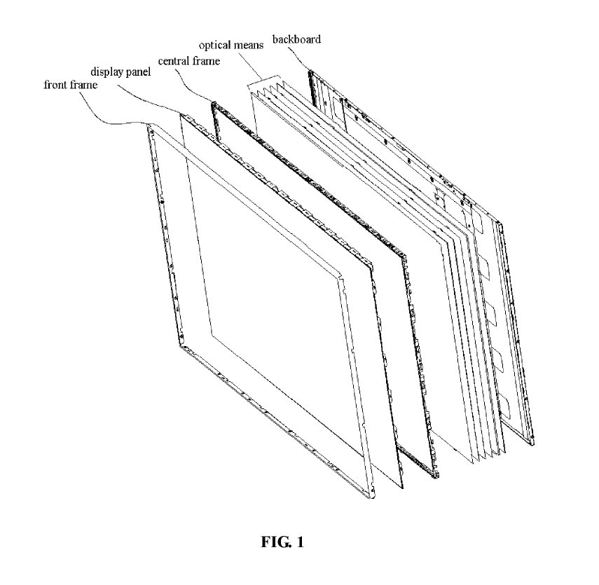

### REFERENCE SIGNS

1: rear cover
2: bottom plate
3: side plate
4: protrusion
5: groove
6: backlight source
8: recess
9: electrical connection terminal
10: film hanger
11: accommodating cavity
13: optical film
31: front surface of first step
32: side surface of first step
41: front surface of second step
42: side surface of second step
7: light guide plate
71: reflective sheet

### DETAILED DESCRIPTION

Various exemplary embodiments, features and aspects of the present disclosure will be described in detail with reference to the drawings. The same reference numerals in the drawings represent components having the same or similar functions. Although various aspects of the embodiments are shown in the drawings, it is unnecessary to proportionally draw the drawings unless otherwise specified.

Herein the term “exemplary” means “used as an instance or example, or explanatory”. An “exemplary” embodiment given here is not necessarily construed as being superior to or better than other examples.

Numerous details are given in the following embodiments for the purpose of better explaining the present disclosure. It should be understood by a person skilled in the art that the present disclosure can be realized even without some of those details. In some of the examples, methods, means, units and circuits that are well known to a person skilled in the art are not described in detail so that the principle of the present disclosure become apparent.

### Embodiment 1

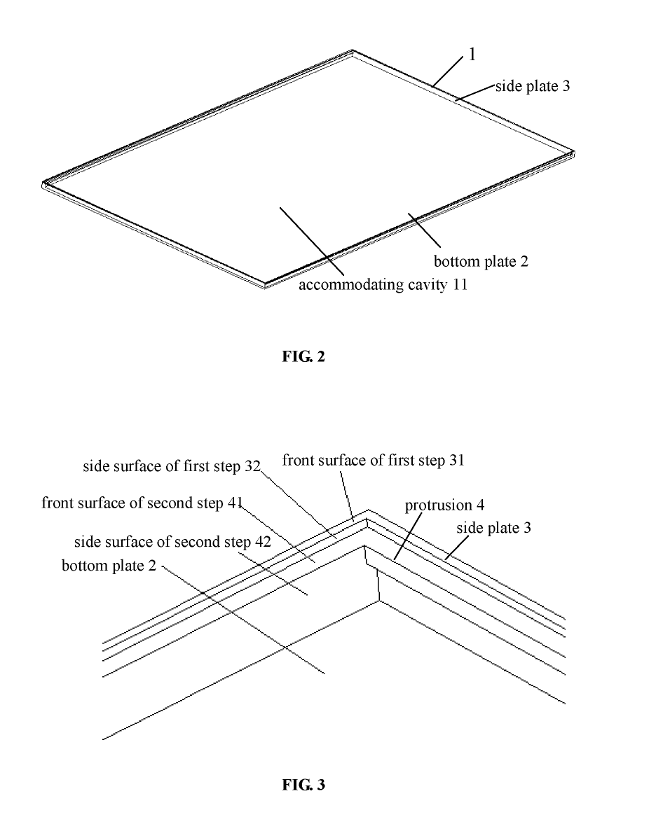

FIG. 2 is an overall diagram of a rear cover of backlight module according to an embodiment of the present disclosure. As shown in FIG. 2, the rear cover 1 of backlight module may mainly include a bottom plate 2 and one or more side plates 3. The side plates 3 may be provided on the periphery of the bottom plate 2 and extend in a direction substantially perpendicular to an upper surface of the bottom plate 2, so that the accommodating cavity 11 is formed and surrounded by the bottom plate 2 and the side plates 3.

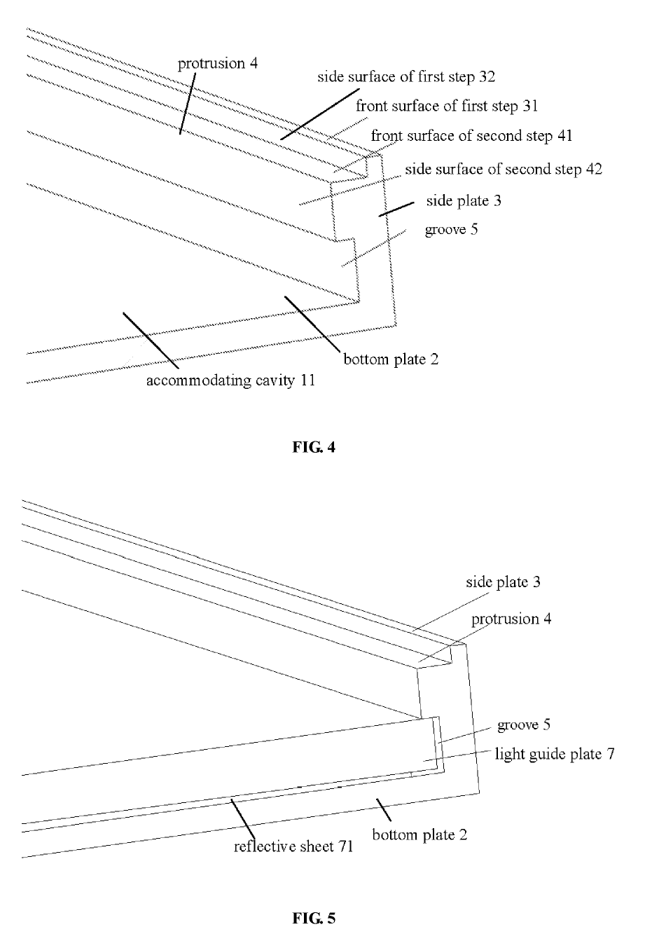

As shown in FIGS. 3 and 4, the inner surface of the side plate 3 is provided with the protrusion 4 protruding toward the inside of the accommodating cavity 11. The protrusion 4 may extend in a direction substantially parallel with the inner surface of the side plate 3, so that the protrusion 4 protrudes toward the inside of the accommodating cavity 11.

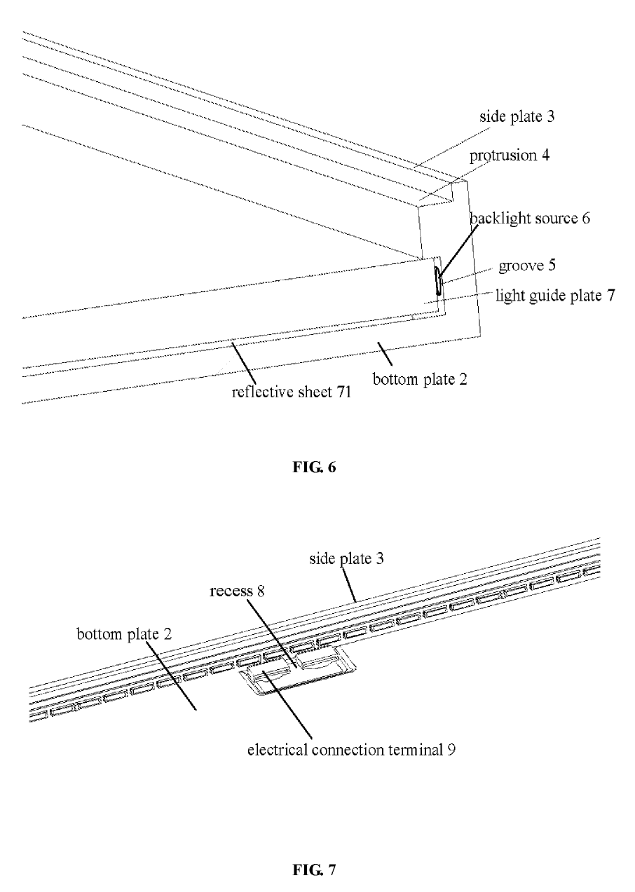

As shown in FIGS. 5 and 6, the groove 5 is formed between the protrusion 4 and the bottom plate 2. The backlight source 6 may be provided within the groove 5, and the groove 5 may be further used for fixing the light guide plate 7. Preferably, the protrusion 4 may be provided on the inner surfaces of two side plates facing each other such that when the light guide plate 7 is installed, the light guide plate 7 can be inserted into the groove 5 under the protrusion 4 because of the bendable property of the light guide plate 7, so as to be fixed. Alternatively, the protrusion may be provided on the inner surfaces of three or four of side plates. On this condition, one of the side plates 3 might be set to be demountable so as to facilitate the assembly.

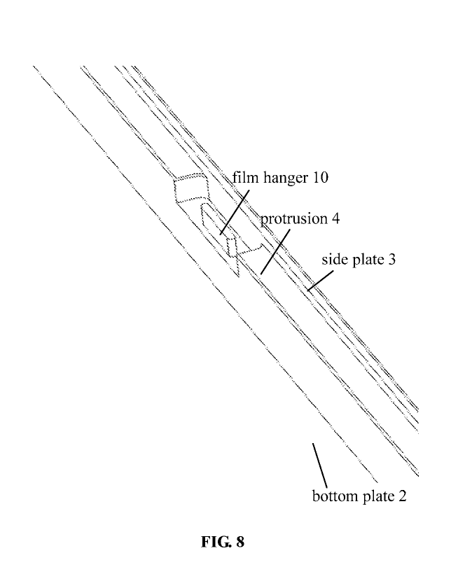

In this embodiment, the backlight source 6 is preferably a light bar made of LEDs (Light Emitting Diode), as shown in FIG. 7. It can be understood that the backlight source 6 includes but is not limited to a flat fluorescent lamp, a bulb, a light bar made of LEDs, a linear light source made of cold cathode fluorescent tubes, a strip shaped EL (electroluminescent), OELD (Organic Electroluminescent Diodes), and so on. Any illumination device that can be used as a backlight source of a backlight module is applicable in the present disclosure. The backlight source 6 of the present disclosure may also be various combinations of the abovementioned light sources.

In this embodiment, the rear cover 1 may have a rectangular shape and includes four side plates 3 and a bottom plate 2, and the groove 5 formed by one of the side plates 3 and the bottom plate 2 may be used to accommodate the backlight source 6. Referring to FIG. 6, the backlight source 6 and the light guide plate 7 may be located on the same side. Further, if the side accommodating the backlight source 6 is used as a light entering side, the light guide plate 7 may be fixed inside the groove 5 formed by the bottom plate 2 and the side plate 3 which is opposite to the light entering side. The groove 5 might have functions of pressing and storing the light guide plate 7. At least one side of the light guide plate 7 can be clamped into the groove 5 so as to prevent the light guide plate 7 from warping. As shown in FIGS. 5 and 6, the reflective sheet 71 is attached between the lower surface of the light guide plate 7 and the upper surface of the bottom plate 2. The size of the reflective sheet 71 may be set according to the size of the light emitting area. Though in this embodiment, the backlight source 6 is provided in the groove 5 formed by the bottom plate and one of the four side plates of the rear cover 1, it can be understood that the backlight source 6 can be provided in the groove 5 formed by the bottom plate and two, three or four of the side plates of the rear cover 1. According to the demand of application, the backlight source 6 may fill up the groove 5 formed by one side plate and the bottom plate of the rear cover 1 or the groove 5 formed by several side plates and the bottom plate of the rear cover 1, or fill up a part of the groove 5 formed by one or more side plates and the bottom plate of the rear cover 1.

Preferably, the rear cover 1 may be formed by plastic materials. In this embodiment, the rear cover 1 may be formed by cast aluminum or cast magnesium to achieve high intensity and light weight. However, the material for the rear cover 1 of the present disclosure is not limited to the above materials, and it may include but is not limited to metal materials such as aluminum alloy, cast aluminum and cast magnesium, and high polymer materials such as plastic resin. In this embodiment, the components of the rear cover 1 may be produced by an integral forming process. The integral forming process, according to the different materials, may select from processing methods including but not limited to punching, press molding, integral casting, injection molding, and hot-pressing.

The rear cover 1 of the present disclosure, however, may be manufactured separately according to the designs. The components, including the bottom plate 2, the side plate 3, the protrusion 4 and so on, can be connected by methods including but not limited to bonding, welding, riveting, and joggling.

The rear cover of this embodiment has a simple structure. By providing the protrusion and the groove, the front cover and the central frame can be removed in the assembly of a backlight module or a display module, thereby reducing the weight, facilitating manual assembly, and decreasing the cost for human force and materials.

### Embodiment 2

FIG. 7 is a diagram showing a recess provided in a rear cover of backlight module according to another embodiment of the present disclosure. This embodiment includes all the technical features of Embodiment 1 and further modifies the structure of the rear cover 1 by adding some new components. The reference signs of FIG. 7 that are the same with FIGS. 2-6 indicate the same components, the details of which will be omitted for concision.

In Embodiment 2, the recess 8 for accommodating the electrical connection terminals 9 of the backlight source 6 may be provided on the bottom plate 2 which is adjacent to the groove 5 at the light entering side, as shown in FIG. 7. There may be one or more recesses. All of the terminals may be placed in one recess 8. Also, a recess may be respectively provided for each of a plurality of terminals. The electrical connection terminals 9 can be connected to an external power (not shown) so as to supply power for the backlight source 6. In addition, the power wire (not shown) of the backlight source 6 might be extremely thin, for instance, in this embodiment, is about 0.1 mm. The power wire may be attached to the inner surface of the rear cover 1, so that the wiring of the backlight module or display module has a better appearance and is safer.

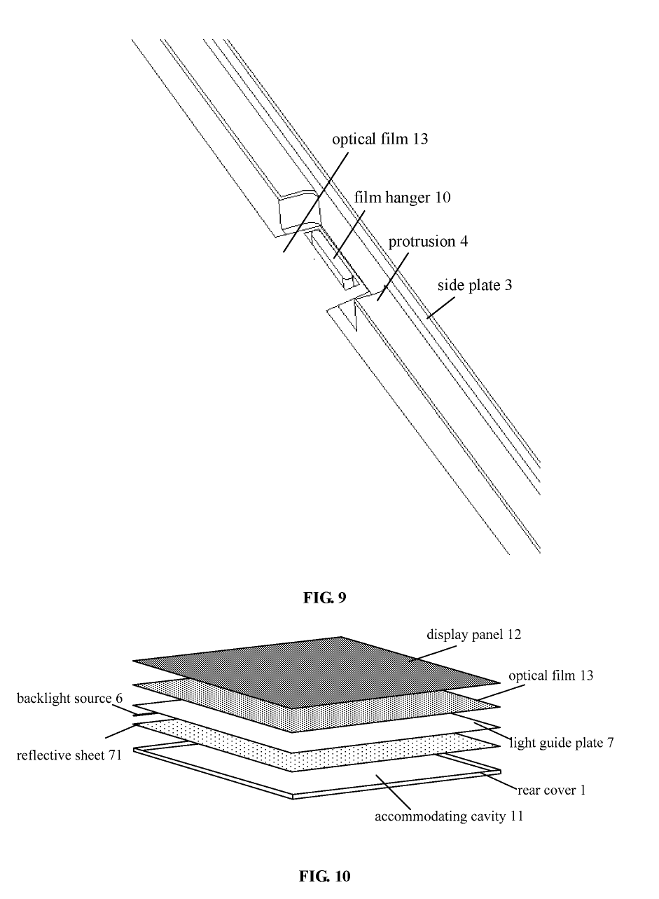

As shown in FIGS. 8 and 9, in one possible implementation, a plurality of film hangers 10 may be provided on the protrusion 4 for locating and fixing the optical film 13, such that the optical film 13 located above the light guide plate 7 can be hitched to the film hanger 10. Specifically, as shown in FIG. 7, a recess may be formed on the protrusion 4, and the protruding film hanger 10 is provided in the recess. The depth of the recess may be determined according to the thickness of the optical film 13 and is preferably determined such that the optical film 13 happens to be attached to the upper surface of the light guide plate 7 when the optical film 13 is hitched to the film hanger 10. The structure of the film hanger 10 shown in FIGS. 8 and 9 is merely an exemplary example, and the protruding film hanger 10 can also be provided on a side surface 42 of a second step of the protrusion 4, without a recess formed in the protrusion 4. Also, a connection between the optical film 13 and the protrusion 4 might be realized by other structures.

The rear cover of backlight module in this embodiment is simply-structured. By providing the protrusion and the groove, the front cover and the central frame can be removed in the assembly of a backlight module or display module, thereby reducing the weight, facilitating manual assembly, and decreasing the cost of labor and materials. In addition, by providing the recess, the structure of the backlight module becomes more compact, which helps to make a backlight module or a display module be lighter and thinner.

### Embodiment 3

This embodiment provides a backlight module using the rear cover 1 according to the afore-mentioned embodiments. Specifically, the backlight module of this embodiment is assembled in order of the rear cover 1, the reflective sheet 71, the backlight source 6, the light guide plate 7 and the optical film 13. The rear cover 1 may have any structure as described in the afore-mentioned embodiments. Referring to FIG. 6, the reflective sheet 71 is placed above the bottom plate 2 of the rear cover 1. The groove 5 of the rear cover 1 is used to accommodate the backlight source 6 that is located above the reflective sheet 71. The light guide plate 7 is placed above the reflective sheet 71 and the backlight source 6. At least one side of the light guide plate 7 is clamped into the groove 5. The optical film 13 is placed above the light guide plate 7 and connected to the protrusion 4 of the rear cover 1.

By using the rear cover 1 integrally formed according to the afore-mentioned embodiments, a backlight module is obtained by assembling the reflective sheet, the backlight source, the light guide plate and the optical film in this order. Since the rear cover is simply structured, the backlight module is easy to assemble. As there is no need for the front frame and the central frame, the weight of the backlight module can be reduced, also, the production efficiency can be improved and the cost can be reduced.

### Embodiment 4

FIG. 10 is a structural diagram of a display module according to an embodiment of the present disclosure. As shown in FIG. 10, the display module may include the display panel 12 and the backlight module, which might be a backlight module as described in Embodiment 3. Moreover, the display panel 12 covers the optical film 13 of the backlight module and is fixed to the protrusion 4 located on the side plate 3 of the rear cover of the backlight module.

Specifically, referring to FIGS. 6 and 9, the protrusion 4 of the rear cover 1 has a substantially rectangular shape. The inner surface of the side plate 3 that is not provided with the protrusion 4 is constructed to have a step structure. The upper surface of the step structure is located in the same plane with the upper surface of the protrusion, thus the inner surface of the side plate 3, the upper surface of the step structure and the upper surface of the protrusion may be used to locate and limit the display panel 12. During the assembling process, an adhesive may be applied to coat the inner surface of the side plate 3, the upper surface of the step structure and the upper surface of the protrusion 4, a display panel may cover the optical film 13 and be attached to the inner surface of the side plate 3, the upper surface of the step structure and the upper surface of the protrusion by the adhesive, so that the display panel is fixed to the side plate 3 of the backlight module.

In one possible implementation, the upper surface of the side plate 3 may be a curved surface so that a smooth transition from the edge of the display panel 12 to the side plate 3 can be realized.

In one possible implementation, the upper surface of the side plate 3 may be a planar surface. Thus, as shown in FIGS. 4-6, it can be said that the side plate 3 has a three-step structure, with the front surface 31 of the first step located on the upper surface of the side plate 3, the side surface 32 of the first step located on the upper inner surface of the side plate 3, the front surface 41 of the second step located in the same plane with the upper surface of the protrusion 4 (the upper surface of the protrusion 4 can be deemed as a part of the front surface 41 of the second step), the side surface 42 of the second step extending from the front surface 41 of the second step perpendicularly to the lower surface of the protrusion 4 or the bottom surface, and the bottom surface equivalent to the front surface of the third step. On this condition, the display panel 12 may be adhered to the side surface 32 of the first step and the front surface 41 of the second step.

The display module is obtained by assembling the backlight module in Embodiment 3 and the display panel. Since the rear cover is simply structured, the backlight module is easy to assemble. As there is no need for the front frame and the central frame, the weight of the display module can be reduced, also, the production efficiency can be improved and the cost can be reduced.

Afore-mentioned are merely specific embodiments of the present disclosure, but the protection scope of the present disclosure is not limited to these embodiments. Within the technical scope disclosed in the present disclosure, changes or replacement that may easily occur to any one skilled in the art should be included within the protection scope of the present disclosure. Therefore, the protection scope of the present disclosure should be subject to the protection scopes of the claims.

1. A rear cover of a backlight module, comprising:
a bottom plate and a side plate, wherein an accommodating cavity is formed by the bottom plate and the side plate, and
a protrusion protruding toward an inside of the accommodating cavity provided on an inner surface of the side plate, wherein a groove configured to accommodate a backlight source and configured to fix a light guide plate is formed between the protrusion and the bottom plate.

2. The rear cover of a backlight module according to claim 1, wherein a recess configured to accommodate an electrical connection terminal of the backlight source is provided on a part of the bottom plate adjacent to the groove.

3. The rear cover of a backlight module according to claim 1, wherein a plurality of film hangers are provided on the protrusion such that an optical film located above the light guide plate is capable of being hitched to the film hangers.

4. The rear cover of a backlight module according to claim 1, wherein the protrusion is provided on inner surfaces of two side plates facing each other.

5. The rear cover of a backlight module according to claim 4, wherein a step structure is formed on a part of the inner surface of the side plate that is not provided with the protrusion, and an upper surface of the step structure is located in a same plane with an upper surface of the protrusion, so as to support and fix a display panel cooperatively.

6. The rear cover of a backlight module according to claim 1, wherein the side plate is configured to extend in a direction substantially perpendicular to an upper surface of the bottom plate, and the protrusion is configured to extend in a direction substantially parallel with the inner surface of the side plate.

7. The rear cover of a backlight module according to claim 1, wherein the rear cover is formed by a plastic material.

8. The rear cover of a backlight module according to claim 1, wherein the rear cover is integrally formed.

9. A backlight module formed by assembling the rear cover according to claim 1, a reflective sheet, a backlight source, a light guide plate, and an optical film, sequentially.

10. A display module comprising the backlight module according to claim 9 and a display panel, wherein the display panel is configured to cover the optical film of the backlight module from above and to be fixed to the protrusion located on the side plate of the rear cover of the backlight module.
